(19) United States
(12) Patent Application Publication
(10) Pub. No.: US 2018/0367673 A1
(43) Pub. Date: Dec. 20, 2018

(54) ENHANCED COMMUNICATION USING VARIABLE LENGTH STRINGS OF ALPHANUMERICS, SYMBOLS, AND OTHER INPUT

(71) Applicant: Bronson Picket, (US)

(72) Inventor: Bronson Picket, (US)

(21) Appl. No.: 15/739,408

(22) PCT Filed: Jan. 25, 2017
(86) PCT No.: PCT/US17/14837

§ 371 Date: Dec. 22, 2017

Related U.S. Application Data
(60) Provisional application No. 62/439,328, filed on Dec. 27, 2016.

(51) Int. Cl. H04M 7/12; H04M 3/56; H04M 3/51; H04L 29/12; G06F 17/30

(52) U.S. Cl. CPC H04M 7/128; H04M 3/567; H04M 3/5141; G10L 17/22; H04L 61/106; G06F 17/30032; H04L 61/605

(57) ABSTRACT

The present invention is directed to a method of routing a voice call and establishing a connection between two or more parties. The method of the present invention employs utilization of character strings, where the strings may include symbols consisting of, but not limited to, numeric digits, letters, biometrics, special characters (emoji, punctuation, symbols, multi-lingual character sets, etc.), pictures, sound, or any combination thereof. In addition, the character strings can be of variable length and are unrelated necessarily to the geographic location of the parties or their switching centers. Some of the symbols in the character string may be used for enhanced functionality.

### BACKGROUND OF THE INVENTION

### Field of Invention

This invention generally relates to a method of communication device dialing for the purpose of making a voice, video, or messaging call between two or more parties, where the parties could include an accessible device.

### Description Of The Prior Art

Typically, communication devices for voice calls, such as telephones, include a dial pad for a user to input a numeric telephone number. The length of the number (quantity of digits) is generally determined by the geographic location of the party being called. For example, in the United States and Canada, assigned phone numbers must comply with the North American Numbering Plan (NANP) Standards set forth by NANPA (North American Numbering Plan Administration) which requires that telephone numbers consist of only numerics of a particular sequence of ten digits; including an initial three-digit area code (or “NPA”, Numbering Plan Area), followed by a three-digit central office or exchange code (referred to as an NXX), followed by four digits for the line number. Although in some cases ten-digit dialing is common, in other cases, such as in some locales where the area has no area code overlays, seven-digit dialing (or another abbreviated dialing plan) may be permissible for calls within the area, but some areas have implemented mandatory ten-digit dialing even within the area. Compliance with the Standards was necessary for common utility of switching and transport equipment in carrier networks.

A prefix is typically required for calling outside a common area. For example, direct-dialed calls to Europe from the U.S. require an international dialing prefix of 011 in advance of the country code.

Around the world, different countries employ varying standards, but with two constant requirements.

The first requirement is related to the number of digits in the phone number, which must be fixed based on the local regulatory parameters of the geographical location to which the phone number is assigned. In the United States and Canada, for example, telephone numbers are 10 numeric digits which are largely assigned based on geographic area (area code or NPA) and local central office (NNX). Traditionally, PSTN routing utilizes the NPA and NNX for aspects of call completion such as billing and trunk seizure.

The second requirement is that the assigned number be numeric only. While an assigned phone number may be publicly represented using letters, each letter must still correspond to a number. That is, telephone processing equipment expects pulses or tones representative of numeric digits, not letters or other characters. For example, on a telephone keypad, where the number “2” is represented by the letters “A”, “B”, and “C”, a business that advertises its phone number as a word or words actually uses the letters in the word to represent corresponding numbers. “THE-BATS” corresponds to a numeric sequence of 8-4-3-2-2-8-7. “THE-CATS”, however, would also correspond to the same numeric sequence of 8-4-3-2-2-8-7, disqualifying these two words from representing distinct phone numbers assigned in the same geographical area. The present invention is intended, at least in part, to overcome this restriction.

Historically, on traditional telephone dial pads, letters are used as alternatives to numbers as follows:
2=ABC
3=DEF
4=GHI
5=JKL
6=MNO
7=PQRS
8=TUV
9=WXYZ

In actuality, the communications switching equipment only recognizes dialed numbers, so even if a user dials (or pushes) the “6=MNO” key so as to dial “N”, it is recorded as a 6. In the present environment, it is impossible to complete a call using anything but numeric digits. Therefore, a number given an alphabetical representation such as “THE-BATS” corresponds to the numeric sequence 8-4-3-2-2-8-7. Similarly, because “B” and “C” are both represented by the number 2, the phone number represented alphabetically as “THE-CATS” will also correspond to the exact same numeric sequence of 8-4-3-2-2-8-7, making it impossible for these two words to be assigned as distinct phone numbers in the same geographical location.

### SUMMARY OF THE INVENTION

The present invention is directed to a method and system for enhanced communications from that presently available by permitting dialing strings extending beyond merely numerics of fixed length. The method and system stem from an ability to perform translation of multi-character strings and a database established for the purpose of providing such translations.

In the system and method of the present invention, dialing sequences (“Calling Sequences”) can be of any length (including ones non-conformant with present PSTN standards). Calling Sequences can be of a combination of numbers, letters, and special characters (punctuation, emojis, etc.) and special functions. Multilingual character sets are also OK. Special functions can include visual, audible, or otherwise sensed content. Calling Sequences can include content extracted from a user's direct input, such as input by voice, and/or input by camera recognition.

In some cases, the Calling Sequence can be sent directly to a database for number translation and in other cases the Calling Sequence can be operated on locally and a consequential digital stream can be sent to the database.

Calls or messages are established as follows:
Using a device, such as an internet-accessible device, a calling party dials a desired called party using a series of entries, such as characters, where the series is defined as any length, any combination of letters and numbers, special characters, etc. and may be different from commonly known character strings, such as but not limited to inclusion of a sound bite (or a digital representation of the sound bite.
The dialing device (or perhaps an intermediate device like a server or router) formulates a message directed to a database. The message includes the dialed Calling Sequence, and may include information related to the calling party and is delivered to a database for a lookup. The message potentially further includes information for querying a remote device.
The database may be remote from the device. The database may have a one-to-one, many-to-one, one-to-many, or many-to-many relationship between Calling Sequences and monikers. For example, a dialing sequence may relate to both a landline and a mobile phone number, and a particular home-based landline may have different monikers related to each of the residents of the home.
The database may also include indications of acceptable types of calls and other available services. For example, a traditional landline phone can be tagged as such so that it cannot be routed a video call or a query intended for an internet enabled appliance.
Similarly, the recipient can establish pre-blocking for selected calls.
The database may return a number selected, at least in part, based on the originator.
The database may return multiple numbers and calls can be established concurrently to different numbers.
The database may also include routing information.
The database may also maintain status of recipient information (e.g., user-designation reach information or being informed of an IP address change, such as due to the user's mobility).
At the database, the Calling Sequence is matched to an IP address and/or a PSTN number. Matched information is returned to the device or to an origination.
The calling device (or an originating server) formulates a set-up message and places the call, which is preferably at least in part an IP-based call.
The call can be peer-to-peer from the origination point without use of an intermediary central server.
Similarly, a conference call can be established using the same process, which could be peer-to-peer sourced from the originating calling device.
As the call continues, if users change, for example, IP addresses, the database is notified and updated, and a process is initiated, possibly from a server associated with the database, to continue or to reestablish the call in real time using the updated information, and potentially informs other party devices so as to keep the call alive. That is, a subsequent look up or database update might occur as a party on the call relocates. Consequently, the present invention affords an aspect of mobility relative to Calling Sequences, which is novel and was not previously available. This renumbering requires a utility built into the devices to communicate with the database in an authorized way and requires the database to be re-contacted or to self contact the calling party for call reestablishment.
Notification of address change to the database may be based on a resident app (or equivalent) element self monitoring the IP address.

The present invention is directed to a method of routing a call and/or establishing a call, or some other form of communication, between two or more parties by using a calling number for each subscriber consisting of a character string extending beyond mere numerics and potentially including numerical digits, letters (multi-lingual), biometrics, special characters (emoji, punctuation, symbols, etc.), visual media, and aural/oral media in any combination. A Calling Sequence may further have functionality features beyond recognition as a destination, such as turning the lights off, or otherwise directing or querying an internet-capable device.

In summary, the present invention uses Calling Sequences which may be of non-uniform length, employs the potential for a mix of a variety of characters (such as combinations of numbers and letters), utilizes the possibility of other non-numeric and non-letter characters (such as emojis), handwriting, and/or other types of input. The database of the present invention can allow for such non-letter and non-number exclusive searching.

In one aspect of the present invention, a Calling Sequence may include just digits, just letters, just biometrics, just special characters, just visual media, just aural/oral media, just DNA, just molecular analysis, just chemical analysis, or some combination of them all or some combination in part.

In the method of the present invention, because a Calling Sequence need not be transmitted as merely numbers, a dial pad (or equivalent) in the present invention does not necessarily correspond to a traditional telephone dial pad. The equivalent of the dialing pad of the present invention could be a traditional dialing pad, but could also be a keyboard which can be altered for differing languages and/or symbols, and could also be another sensor, such as a biometric sensor like a fingerprint or pupil sensor, a visual sensor, an audio sensor, a pad or location for writing (i.e., with a finger or stylus) or some combination.

Because the present invention allows for a variety of characters and other representative entries to represent Calling Sequences, individual letter entries do not correspond to numbers on the dial pad, but are, rather, unique individual entries, the Calling Sequences THE-BATS and THE-CATS may both be assigned within the same geographical location (or in different geographic areas) as distinct Calling Sequences. Further, an assigned calling number, such as THE-BATS, need not conform to a numbering plan like NANP, can be universal, not specific to a geographic locale or region, and there would be no need for a calling party to dial any prefix such as an international code or a country code.

### BRIEF DESCRIPTION OF THE FIGURES

FIG. 1 depicts a smart phone running the present invention on an app.

FIG. 2 depicts sample call flows of the present invention.

FIG. 3 depicts a schematic diagram of at least some apparatus in one or more embodiments of the present invention, together with representative call flows.

### DETAILED DESCRIPTION OF THE INVENTION

The term “call” is used herein to denote any of several types of communication, including but not limited to voice and video calls, FAXes, and one or two way messaging. Similarly, the term “dial” is used herein to denote an action by a user to enter information regarding a distant user.

The present invention is directed to call set up using a variety of dialing techniques, including multi-variable character, variable character, non-uniform length dialing, and other forms of dialing. The user's input may be delivered directly to a database, or be converted to a digital stream as needed. The data or digital stream, which serves as an identifier for a called party, is sent to a database for rapid lookup and conversion to a routing number. A call, be it a call or a message, can be routed directly using the routing number and, potentially, a peer-to-peer call can be established. Similarly, conference calls can be established. Further, the variable length and non-uniform string can be used as an identifier for items associated with a user, such as an internet accessible device, and messages and instructions can be sent to the device.

The methodology of the present invention results in considerable improvement in ease of use, adaptability and functionality. This improvement is attributable to a combination of factors including (a) friendliness of Calling Sequences, (b) usability, (c) functionality, (d) globalization (different languages and character sets, symbols, etc.) (e) uniqueness of string regardless of country or language, (f) the structure of the database that accommodates such a functionality using a vanity portfolio oriented database, and (g) connectivity over any networking environment i.e., WiFi, LTE, 3G, 4G, CDMA, GSM, Bluetooth, WAN, MPLS, SD WAN, Internet, VPN, IP based communications, or any other current or future type of networking environment.

Broadly speaking, in addition to communication devices at each end for at least voice to voice or text to text communications, the system of the present invention includes at least the following elements:
A calling device, such as a telephone or computer, with connectivity to a keypad or another input device or devices usable for entry of information for dialing and potentially for recognition of the calling party. In the preferred embodiment, the keypad includes a variety of numbers, letters, symbols, icons, and so on, for dialing sequences of characters. In other embodiments, alternate or additional devices can be used for dialing, such as, but not limited to, a camera, a microphone, and/or a biometric sensor of some type.
Connectivity to a database for conversion of the dialed sequence to network-understandable routing guidance.
A network for routing.
A receiving device for receiving the call and/or message.

As an example, a user can dial by voice, where the device includes a microphone and includes or has access to speech recognition capability, perhaps in an app. The device would recognize both the caller (e.g., a voice and/or finger print) and the content of the speech. In a further example, the caller could say “SPOUSE” and the present invention would recognize the caller's voice and content and route the call to the person's spouse based upon a database look up of the last known good location for the spouse. The routing would preferably use the Calling Sequence for the spouse.

In another example, the caller may touch his/her left ring finger to a sensor for sensing fingerprints and the device would both recognize the caller and know, through use of that particular fingerprint, that the caller wishes to call his/her spouse. The “touch” may be captured by any device, even a device not associated with the toucher. The print would potentially be digitized and recognized, either by the device or by a sensor and sent to the database of the present invention for translation and call completion. Such a touch can be recognized and acted on by an app on the device or by some other known methodology.

In yet another example, the caller can be positioned in front of a camera and by formulating a series of actions, such as a blinking or hand-movement sequence, a call can be established to a designated individual. Such recognition can be by an app on the device or some other known method.

In all examples described above, once the system of the present invention identifies both the caller and the desired called party, the call can be established as a voice call, a video call, a message, and/or can ring multiple designations as appropriate.

In at least some embodiments, the call might be directed to a plurality of end points (thereby establishing a multi-party conference call).

In summary, the present invention leverages the ability for Calling Sequences that extend beyond merely numbers of fixed length, per the variety of Calling Sequences and their various forms as described herein. Further, the structure of these Calling Sequences can be extended or otherwise adjusted so as to be directed to provide queries or obtain information from a variety of devices, each of which is associated with one or more users. The present invention further leverages a database where such varied Calling Sequences can be stored and each Calling Sequence is associated with network-oriented contact information for actual completion of tasks.

Further, in the method of the present invention, there is no length restriction for the Calling Sequence, nor does the length of the calling number correspond to a geographical location or any dialing plan standard. There is also no minimum or maximum length requirement for the Calling Sequence in the present invention.

In addition, in the method of the present invention, a Calling Sequence is assigned as a moniker for call reception for an individual and that individual, be it a person or a business, can maintain that assigned Calling Sequence forever. The database of the present invention is intended to preclude the same Calling Sequence being assigned to more than one entity simultaneously. The length of the Calling Sequence doesn't change, country codes are not required, nor are area codes required, irrespective of where the calling or dialed party is located relative to the other. For example, in the present invention, a number dialed within the UK using the following series of characters: THE#TARDIS2:) would not require a calling party from the US to dial 011+44 THE#TARDIS2:) to reach the same dialed party. Calling Sequences assigned in the present invention are static and complete without regard for where the calling or dialed parties are located, at any time.

Calls in the present invention are established as follows:

The calling party dials a desired called party using a series of characters and/or actions (dialing the “Calling Sequence”). A series is defined as above (any length, special characters, pictures, sounds, etc.). The dialing is done using a keypad such as, but not limited to, a qwerty keyboard, a microphone, a sensor, or a camera, and a multi-character keypad may be available with any computer, tablet, or smart phone. In many situations, the keypad is adjustable for different languages (e.g., a Hebrew character set can be used in lieu of a Latin alphabet). As such, multilingual Calling Sequences are permissible.

The dialed characters or other entries are received by a computer or server and sent to a database for a lookup using a messaging protocol. This database can exist in a cloud or somewhere else accessible to the dialing device. The database can be a distributed or replicated database.

In the database, the Calling Sequence is potentially matched to an identifier, i.e., serial number or MEID of the sending device, etc. A connection handle is then returned to the device, where the connection handle is a translation of the dialed string to an end point connection number understandable by the network(s) being used for the connection. The connection handle may be a telephone number, an IP address, or some other string which is understandable by a network usable to form a connection. Once the connection handle is returned to the originating end, the call can be set up and established.

The connection handle being returned may be selected based on the requester.

The connection handle being returned may be returned with routing information.

The data being returned may include a plurality of connection handles, such as if the called party is reachable in a plurality of ways.

The call can be established as, for example, peer-to-peer without use of an intermediary central server or a call that uses an intermediary server. Peer-to-peer networking affords additional opportunities, such as decentralized conference calling and multi-platform conferencing calling (such as some users on video, some on voice only). Further, by using peer-to-peer approaches, mobility aspects can interact with the database of the present invention and therefore afford automated database updates. Further, peer-to-peer connections eliminate intermediate switching, thereby improving reliability and cost.

The methodology of the current invention exponentially increases the combination of possible Calling Sequences available to users. It also simplifies the complexities associated with making international calls by removing the need for country codes, area codes, central office (exchange) codes and line numbers. Rather, the user's calling number remains constant and unchanged, no matter where the user is located, if the caller moves, and no matter from where the user who is being called happens to be.

This methodology is not limited to calls between human beings, i.e., it may include calls directed to or from appliances, animals (or devices attached to or associated with an animal), other Internet of Thing (loT) devices, etc.

Calling Sequences within the method of the present invention also include the possibility for creating sub-Calling Sequences, such as by adding a suffix. For example, a user whose calling number is JOHN212 may have a sub-number JOHN212.WIFE or .WIFE for calling his own wife. Dialing the sub-number in this example could call the user's wife directly, no matter which receiving device she happens to have nearby. Sub-numbers may also include non-human entities such as a smart appliance; e.g., JOHN212.OVEN. The database of the present invention can be arranged to restrict access to certain recipients, such as those indicative of internet-accessible appliances, at least in part for security reasons.

Because Calling Sequences in the present invention include all manner of symbols and characters, Calling Sequences can also carry information such as instructions, i.e., dialing a smart oven with the instruction to pre-heat to 350 degrees Fahrenheit; JOHN212.OVEN/PH350F. In the previous example, a period was used to denote a sub-number (JOHN212.subnumber), and a forward slash to denote instructions (JOHN212.subnumber/instructions), however, sub-numbers and instructions need not be limited by this template, nor must instructions consist of only letters. Instructions, like Calling Sequences in the present invention, may also consist of symbols, aural and visual media. Further, instructions are not limited to sub-numbers and may be included with the parent number, or without the parent number when the sub-number in this example is being dialed by JOHN212.

Similarly, using voice recognition, a user could say “PRE HEAT OVEN TO 350” and the system of the present invention could formulate and deliver a message to the oven, by recognizing the user's voice and the content.

The present invention is directed to methods of routing and establishing calls directed to a wide range of targets for a wide variety of reasons (i.e., phone conversation via voice, video, chat, turn on/off lights, turn on/off oven, start alarm, etc.). The database of the present invention need not be structured specifically to the present invention and may have general or specific information about the target and its capabilities, the structure of the calling number and its geographic location and accessibility information, its properties, names, aliases, address, etc. The database of the present invention is sufficiently robust and contains a storage means, preferably compartmentalized, to rapidly return a translated address for routing purposes.

The present invention includes a database in which monikers for a telephone number (and/or an IP address) are stored and associated with one or more Calling Sequences. Each time someone attempts to place a call or set up a communication with another user, the caller may dial a character string (or equivalent as described herein) and, using a messaging protocol such as IP or SS7, a message is sent to the database for look up and translation. Because of the way the string may be established, such as by using particular characters as delimiters for functions, only some of the string may be sent to the database for association.

The database of the present invention includes a relationship between a Calling Sequence and a moniker (and, as noted, it might be a one-to-one or many-to-many relationship). Each moniker can be thought of as contact information for a user. That contact information can itself have fields associated with is, such as fields for various approaches to contact the person (e.g., a plurality of PSTN numbers and a plurality of IP addresses), with each having defined preferences (user preferred sequence of contact, call blocking, etc.). Further, the fields could include fields for intemet ready appliances to be contacted, with specific limitations as to who could be doing the contacting.

The database of the present invention also may be formulated and structured to permit the plethora of contact information such as the voice or fingerprint approach. To validate the proper user, such as, perhaps, when the caller uses voice recognition, it may be best to have the originating device (or a server associated with the originating device) encode the voice print (or finger print) for use by the database. That is, the originating device would prepare a datagram for delivery to the database for database lookup which would include content representative of the voice or finger print (perhaps indication that it is a voice or finger print), as well as information related to the proposed destination of the call. In the present invention, considering the example of the caller using their left ring finger for calling their spouse, the originating device would recognize the caller and deliver a moniker for the caller in the datagram. To further the example, because the caller is the spouse, the call can be flagged in a way, such as to indicate “high” priority.

The database of the present invention also may include fields indicative of means for connectivity or further connectivity instructions. For example, supposing one wanted to query an intemet-capable appliance such as an oven. The contact information for the oven might be accessible through an IP address, and connectivity to the IP address might be available over an IP-only connection or optionally over a partial PTSN connection (in combination with some IP access). Information may be returned from the database indicating such options.

The database of the present invention preferably includes attributes for robustness. In one embodiment, the database includes a table of consecutively numbered or ordered keys and records, where each key is numbered for its memory location and each record is associated with one key. In another embodiment, each key is named for its location address. In another embodiment the database is a portfolio database structured based on lookup and translation of variable length strings and is indexed for speed relative to said lookups. In a further embodiment, the database may be compartmentalized.

In the present invention, while the caller may intend to call an internet capable device so as to deliver a message (or otherwise communicate with the device), the caller would be afforded the opportunity to select the contact device (e.g., MY.OVEN) and the message (CHECK STATUS, INCREASE TEMPERATURE, etc.). the selection may be by way of an app. For such a process to occur, the calling number would need to be identified, such as through the database, and the caller authenticated. Once that is completed, a message would be sent directed to the internet capable device. In this instance, the message would potentially be encrypted and sent to a device at the location of the oven, such as a local router. The router would then potentially restructure the message to convey the desired request over a local IP network (or equivalent) to the oven, which would correspondingly reply as appropriate.

In addition, the database entry may identify the types of available communications, such as voice only, video only, fax, or combinations. The sending device may identify the caller's preferred communication means, and match the outgoing call accordingly. Further, the database entry may have a one-to-one, one-to-many, many-to-one, or many-to-many relationship, such as having a plurality of monikers associated with a plurality of telephone numbers, and some might be transient. For example, a user might be known as JOHND, JDOE, JOHNDOE, and JD, and the database may associate each of them (or a subset) respectively, with a mobile phone number, a home phone number, and a vacation home phone number.

In the prior art, dialing is done using a calling number with a predefined size and format. The call can connect a voice, video, chat or fax device where the end device's functionality constitutes of turning on or off the connection. The present invention extends prior capabilities by allowing a user to select a friendly “number” as a phone number i.e., John Doe may create a dialing number that is JDoe or JohnDoe.Oven, etc. A user may also create a phone number that checks the status of Internet enabled devices, such as an oven, or turns the oven on or off. For example JDoe.Oven for status, JDoe.Oven/OFF for turn off oven or straight JDoe to call John Doe, such as adding a “.” or “/” as a delimiter or for another purpose. Despite references herein to a keypad, all of the above can be accomplished with a graphical user interface, or other/additional interfaces. If the call is intended to learn status, the receiving device would be taught to provide the information to the call's termination point and return a message with the requested status. Message formatting can be based on, for example, a drop-down menu on a smart phone.

A call of the present invention is routed based on the moniker returned from the database. As noted above, the type of call, be it a voice call, a conference call, a query for information, or a video call, or some other type of call, is determined based on the moniker returned. The call may be routed over the public IP network, the PSTN, a private IP network, another data-based protocol network, or some combination. As appropriate, some or all routing information may be encrypted to aid in security, with such encryption being handled by either the look up database, a third party device such as a dedicated encoder, or the originating device.

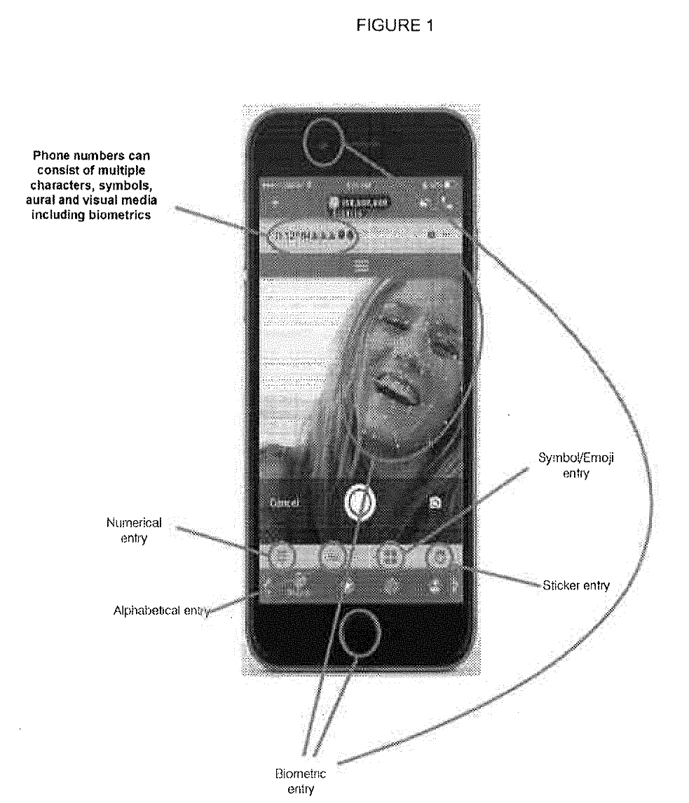

FIG. 1 depicts a typical smart phone with a screen shot of a call being dialed via biometrics using the smart phone and the present invention. In one embodiment of the present invention an app could be available for call arrangement and completion. As seen in FIG. 1, phone numbers can be displayed as character strings. In one embodiment, a biometric entry can be used as the “number” to call the called party. The biometric entry of the present invention could be a fingerprint, facial recognition, voice recognition, or some combination. In one embodiment, the database of the present invention, or an associated database, could be employed to validate the collected biometrics or, in an alternative embodiment, the biometrics could be authenticated on the device itself. If authentication is at the database, the device would be guided to deliver a structured message to the database so as to accelerate its ability to authenticate. A digitized version of the biometric data can serve as the “Calling Sequence” and used for database lookup. In another embodiment, handwriting recognition may be used for authentication.

As shown on the lower part of the screen, a caller would have the opportunity to enter data on a variable keypad by selecting the keypad of preference, be it numeric, symbolic, alphabetic, biometric or sticker.

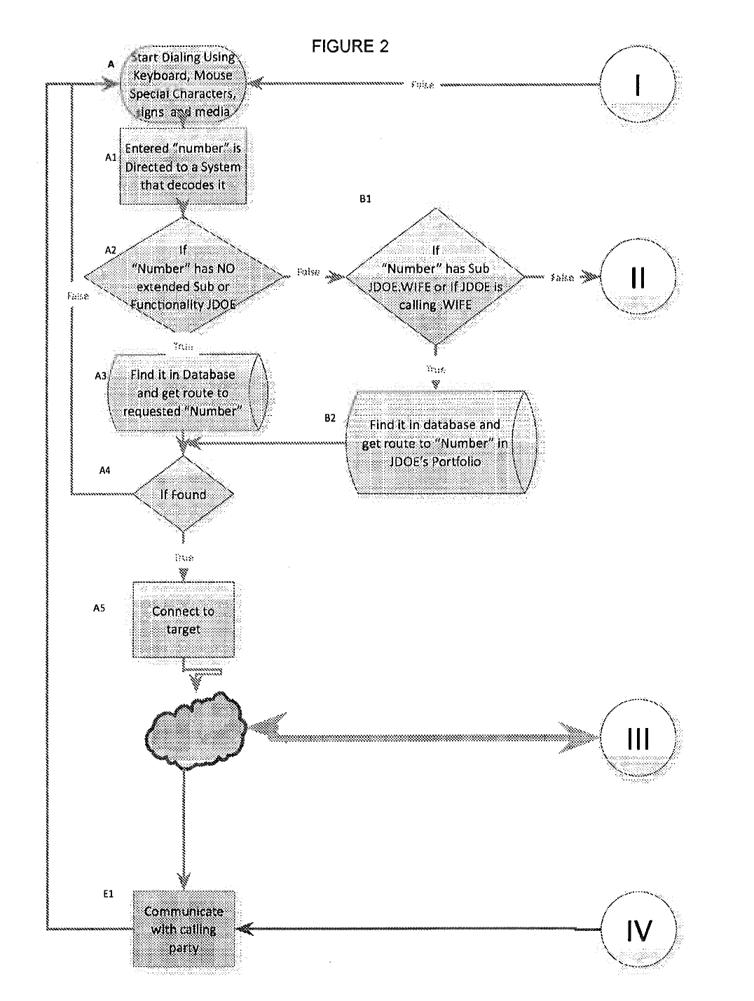

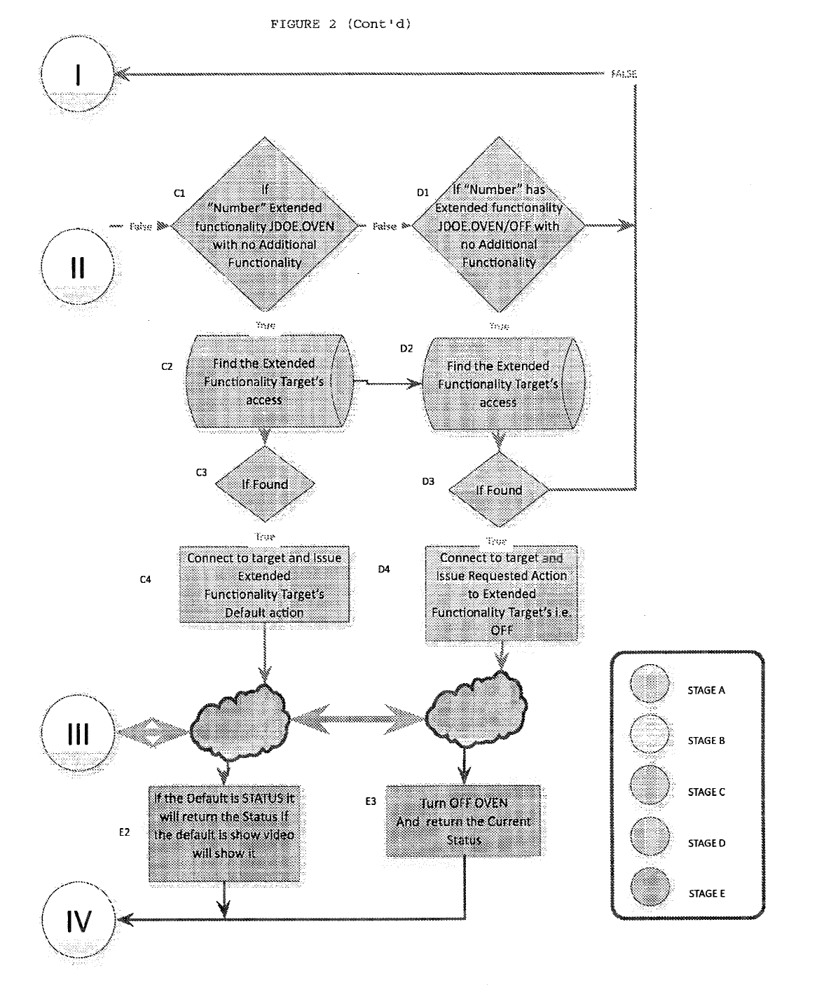

With reference to FIG. 2, the following depicts sample call flows in the method of the present invention:
A. The user (caller) dials the “number” of the party he is calling into the dial pad using whatever combination of special characters of which the called party's “number” consists.
   1. Upon the user pressing “send” or some other equivalent, the dialed number is directed to a database (or equivalent) to decode the string and check whether the dialed number was sent with additional data including, but not limited to instructions, or whether the dialed “number” is being routed to the sub of a main number.
   2. If the dialed “number”, when checked against the system decoder, is not the sub of a larger number and does not include additional hierarchical functionality data to be relayed elsewhere...
   3. . . . then the dialed “number” is checked against the database to insure it does, in fact, exist in the system, and to then find the route information for that “number” in order to complete the call.
   4. If the dialed “number” is found in the system . . . .
   5. . . . routing information is supplied to insure the caller and called party are able to terminate their call.
B.
   1. From A.2, if the dialed “number” IS the sub of a main number, but that sub number is not capable of retrieving additional hierarchical functionality data, then . . . .
   2. . . . the dialed sub “number” is searched for in the database to retrieve routing information for completing the call.
C.
   1. If the dialed “number” is a sub number AND is capable of receiving additional hierarchical functionality data,
   2. then the sub number along with the requested default functionality are searched for in the system to determine how the target needs to be accessed to carry out the functionality request
   3. If the sub number and means for carrying out the default functionality request are found in the system, then. . . .
   4. The calling user's device receives the information allowing it to connect with the sub number target, i.e., device, and carry out the functionality request, i.e., report current oven status.
D.
   1. If the dialed “number” is a sub number AND is capable of receiving additional hierarchical functionality data, AND there is a functionality action requested, i.e., turn off Jane Doe's oven,
   2. then the sub number along with the requested extended functionality are searched for in the system to determine how the target needs to be accessed to carry out the functionality request or requests, i.e., report oven status, heat to 450 F for 35 minutes, then turn off.
   3. If the sub number and means for carrying out the functionality request or requests are found in the system, then. . . .
   4. The calling user's device receives the information allowing it to connect with the sub number target, i.e., device, and carry out the functionality request or requests, i.e., report current oven status, pre-heat oven to 450 F, turn on oven light
E.
   1. Having received the routing information for the target device, the user (caller) is able to terminate a call to the target recipient.
   2. Having received the routing information for the target device as well as the means for carrying out the default functionality requested of the target, the user (caller) is able to terminate a call to the target recipient, and carry out a the default action requested of the target, i.e., report oven status.
   3. Having received the routing information for the target device as well as the means for carrying out the default functionality requested of the target, the user (caller) is able to terminate a call to the target recipient, and carry out a the action or actions requested of the target, i.e., report oven status, turn off oven light, activate CLEAN OVEN.

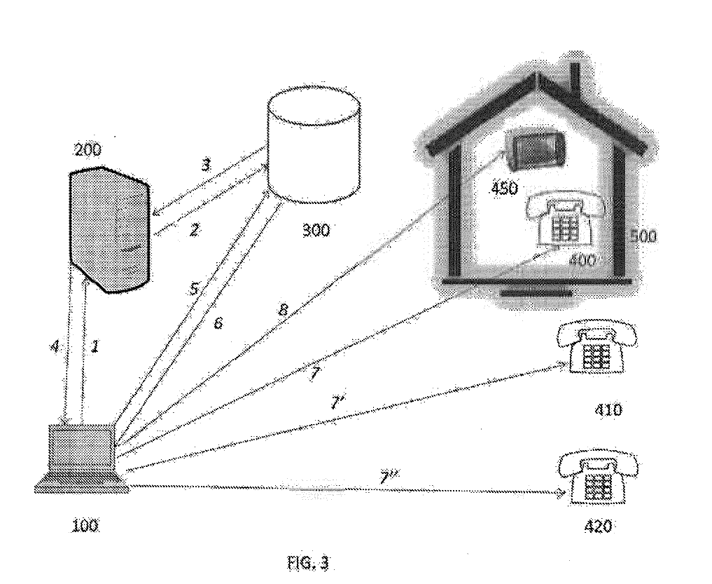

FIG. 3 depicts a schematic diagram of the core components of the present invention together with depicted messaging and call flows. As shown, a call is initiated by user device 100, such as by using a computer, and such a call can be initiated by keying in characters, providing biometric data, audible data, written data or some combination. Although shown as a computer, the device can be another device such as a mobile phone, and the dialing capability and call receiving capability may be in separate devices.

In one embodiment, the present invention includes an intermediate server 200. In one example, the intermediate server is used to receive the content being provided by the user and convert this to a digitized stream. In this embodiment, step 1 includes connectivity to server 200, which delivers a message in step 2 to database 300 for translation of the content of the message into a dialing instruction. The return message follows the return path as shown in steps 3 and 4.

In another embodiment, the intermediate server may not be tied directly to the database. In this embodiment, user device 100 delivers a message directly to database 300 using step 5, with the return message transported using step 6.

At database 300, a translation and, potentially, a messaging instruction for embedding is returned to user device 100 for call set up. Assuming user device 100 is data accessible, user device would then establish a call set up message, such as to terminating device 400 using path 7 for call set up. For a conference call, such as including terminating devices 410 and 420, comparable concurrent call set up can be achieved using paths 7′ and 7″ respectively.

In an alternative embodiment of the present invention, a messaging call can be sent to an internet-accessible device, such as an oven. As shown using path 8, a messaging call can be sent to oven 450 in home 500. Although not shown, the messaging call can be delivered to an in-home router for further distribution to over 450 (or another internet-capable device) and a message, such as an acknowledgement or a response, can be returned.

1-24. (canceled)

25. A method for a networked user device with a user interface to obtain information regarding a network-enabled remote appliance, said user device in communication with a processor-controlled database, said device with ability to communicate with destinations based on different length addresses not limited to numerics, comprising the steps of:
receiving content from a user interface, said content including a representation of a destination address and an instruction for querying a remote appliance;
formulating and transmitting a request for a translated address corresponding to said representation to a processor-controlled database, said database structured for rapid response and for lookup and translation of variable length strings and configured to associate a translated address with a source identifier and any preferred method of delivery, said request including said content and a character string indicative of the querying source, where said character string may be non-numeric at least in part, said processor configured to determine whether said querying source is authorized to contact said appliance;
if said querying source is authorized, receiving in response a destination address associated with said representation and identification of any preferred medium of delivery, said destination address structured for transport over said preferred medium;
formulating a peer-to-peer instructioned query for delivery to said appliance; and
receiving said response in said user interface; and
if said calling source is not authorized, receiving a failure of attempt response;
wherein said database is further configured for accepting internet address queries from a remote device and is configured for storage and lookup of numeric, partially numeric, and non-numeric addresses.

26. The method of claim 25, wherein said user interface or said processor-driven database decodes said content into alphanumerics.

27. The method of claim 25, wherein said content includes any of numbers, letters, and punctuation, and said letters can be from a plurality of character sets.

28. The method of claim 25, wherein said appliance is selected from the group consisting of a refrigerator, an oven, a freezer, a stove top, a microwave oven, a toaster, and a beverage maker.

29. The method of claim 25, wherein said content can be as short as one character.

30. The method of claim 25, wherein said content includes data sourced at least in part from a biometric sensor.

31. The method of claim 30, wherein said biometric sensor is at least in part a sound sensor for detecting at least one of a voice print and voice content.

32. The method of claim 31, wherein said query includes data representative of sensed sound.

33. The method of claim 30, wherein said biometric sensor is a visual sensor.

34. The method of claim 25, wherein said appliance is an audio or video communication device.

35. The method of claim 34, wherein said communication is a multi-party call.

36. The method of claim 25, wherein said instruction is a request for status.

37. A method for a processor in communication with a database to facilitate a direct interaction between a user controlled communication device interface and a network-enabled remote appliance, comprising the steps of:
receiving from an interactive user interface a request for an action related to a remote appliance, said request including an instruction and an indication of the user;
parsing said instruction for an indication of the appliance;
querying a database to determine authorization of said user relative to communicating with said remote appliance and, if authorized, receiving in response a network accessible destination address and routing instructions based on said user; and
structuring a query inclusive of an order for action for peer-to-peer delivery to said destination address;
wherein said database is configured for lookup of variable length strings, for accepting internet address queries from remote devices, and for storage and lookup of numeric, partially numeric, and non-numeric addresses; and is structured and indexed for response speed.

38. The method of claim 37, wherein said instruction includes data sourced at least in part from a biometric sensor.

39. The method of claim 38, wherein said biometric sensor is configured to detect a person based on finger or voice print.

40. The method of claim 37, wherein said biometric sensor is a sound or visual sensor.

41. The method of claim 37, wherein said instruction includes a combination of numbers, letters, and punctuation marks.

42. The method of claim 37, where said user interface is graphical.

43. The method of claim 37, wherein said order is a request for status.

44. The method of claim 37, wherein said appliance is an audio or video communication device.
